(19) United States
(12) Patent Application Publication
(10) Pub. No.: US 2008/0253795 A1
(43) Pub. Date: Oct. 16, 2008

(54) FUSER AND IMAGE FORMATION APARATUS

(75) Inventor: Masahiro ISHINO, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD, Tokyo (JP)

(21) Appl. No.: 11/874,477

(22) Filed: Oct. 18, 2007

(30) Foreign Application Priority Data
Dec. 25, 2006 (JP) 2006-347484
Dec. 25, 2006 (JP) 2006-347506

(51) Int. Cl. G03G 21/20

(52) U.S. Cl. 399/92

(57) ABSTRACT

A fuser includes a fusing press section, a cooling section, a peeling section and a limitation section. The fusing press section has a nip part is between a fixing belt and a pressurization member. The fusing press section fuses a toner image on a record sheet and fixes the toner image on the record sheet. The cooling section cools the record sheet which has the toner image. The record sheet is attached onto the fixing belt. The peeling section peels off the record sheet cooled by the cooling section from the fixing belt. And the limitation section is disposed between the fusing press section and the cooling section. The limitation section limits a move of heat from the fusing press section to the cooling section.

### CROSS-REFERENCE TO RELATED APPLICATIONS

This application is based on and claims priority under 35 USC 119 from Japanese Patent Applications No. 2006-347484 filed Dec. 25, 2006 and No. 2006-347506 filed Dec. 25, 2006.

### BACKGROUND

1. Technical Field

This invention relates to a fuser and an image formation apparatus.

2. Related Arts

It has been made possible to provide a high-quality image by a color image formation apparatus because of improvements of digitization, high definition, etc., in recent years. With higher image quality, an attempt is made to broaden a color image formation apparatus using electrophotography in the print market and the photo market.

### SUMMARY

According to an aspect of the invention, a fuser includes a fusing press section, a cooling section, a peeling section and a limitation section. The fusing press section has a fixing belt given heat and a pressurization member pressed against the fixing belt to form a nip part. The nip part is between the fixing belt and the pressurization member. The fusing press section fuses a toner image on a record sheet by the heat of the fixing belt and fixes the toner image on the record sheet under pressure when the record sheet passes through the nip part. The cooling section cools the record sheet which has the toner image. The toner image is fused and fixed on the record sheet under pressure by the fusing press section. The record sheet is attached onto the fixing belt. The peeling section peels off the record sheet cooled by the cooling section from the fixing belt. And the limitation section is disposed between the fusing press section and the cooling section. The limitation section limits a move of heat from the fusing press section to the cooling section.

### BRIEF DESCRIPTION OF THE DRAWINGS

Exemplary embodiments of the present invention will be described in detail based on the following figures, wherein:

FIG. 1 is a sectional side view to show the configuration of a fuser according to a first exemplary embodiment of the invention;

FIG. 2 is a schematic sectional view to describe paper,

FIG. 3 is a schematic configuration drawing to describe air blowing in the fuser;

FIG. 4 is a block diagram to describe control of a control section;

FIG. 5 is a block diagram to describe the configuration of an image formation apparatus 100 incorporating the fuser;

FIG. 6 is a sectional side view to show the configuration of a fuser according to a second exemplary embodiment of the invention;

FIG. 7 is a schematic configuration drawing to describe air blowing in the fuser;

FIG. 8 is a sectional side view to show the configuration of a fuser according to a third exemplary embodiment of the invention.

FIG. 9 is a sectional side view to show the configuration of a fuser according to a fourth exemplary embodiment of the invention;

FIG. 10 is a schematic configuration drawing to describe air blowing in the fuser;

FIG. 11 is a schematic configuration drawing to describe air blowing in the fuse: according to a modified example of the exemplary embodiments; and

FIG. 12 is a schematic configuration drawing to describe air blowing in the fuser according to another modified example;

### DETAILED DESCRIPTION

Exemplary embodiments to show examples of the invention will be discussed with reference to the accompanying drawings.

### First Exemplary Embodiment

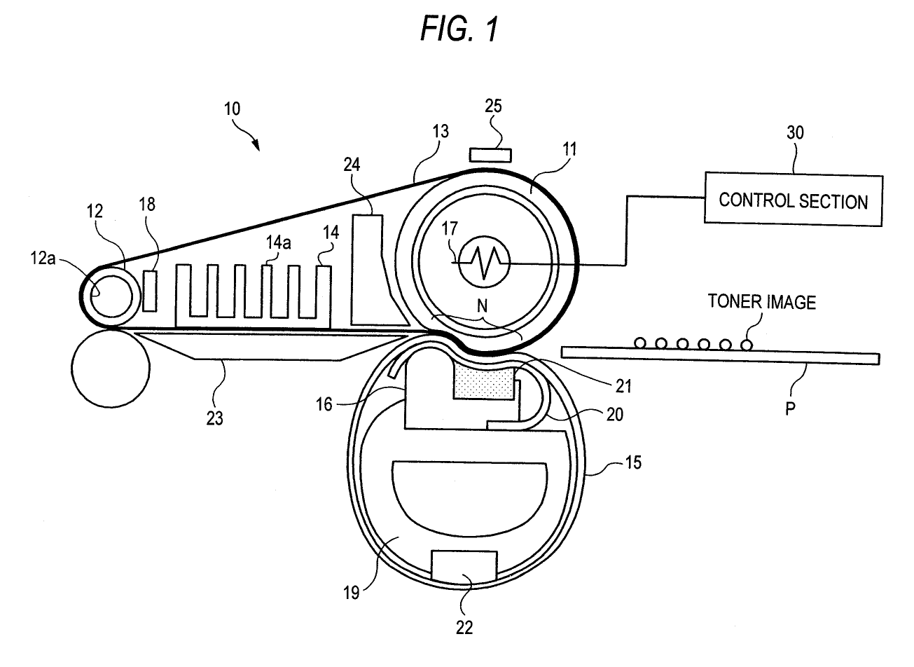

FIG. 1 is a sectional side view to show the configuration of a fuser 10 according to a first exemplary embodiment of the invention.

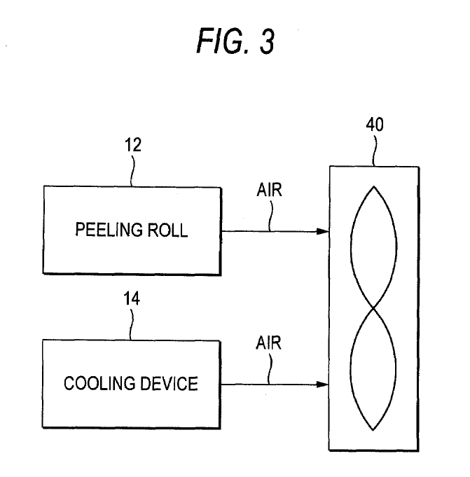

As shown in FIG. 1, the fuser 10 includes a heating roll (rotation member) 11 positioned upstream in the transport direction of paper (record sheet) P, a peeling roll (peeling member, peeling section) 12 positioned downstream in the paper transport direction, a fixing belt 13 stretched between the heating roll 11 and the peeling roll 12, a cooling device 14 positioned in the space surrounded by the fixing belt 13 and positioned between the heating roll 11 and the peeling roll 12, a pressurization belt (pressurization member) 15 placed facing the heating roll 11, and a pressure pad (press part, pressure member, hard pad) 16 positioned on the inner peripheral surface of the pressurization belt 15 and pressed front the heating roll 11 through the pressurization belt 15. The heating roll 11, the fixing belt 13, the pressurization belt 15, and the pressure pad 1G make up a fusing press section. The peeling roll 12, the cooling device 14, and a blowing section 40 (described later with reference to FIG. 3) make up a cooling section.

The heating roll 11 is a cylindrical roll supported for rotation and rotating at predetermined surface speed. For example, a halogen heater 17 rated as 600 W is disposed in the heating roll 11 as a heating source. A toner image formed on paper P is heated by the heat of the halogen heater 17. On the other hand, a temperature sensor 18 is placed in contact with the surface of the peeling roll 12. This temperature sensor 18 is provided for detecting the surface temperature of the peeling roll 12.

The peeling roll 12 is a roll for promoting peeling of paper (object to be fixed) P transported in an abutment state against the fixing belt 13 by stretching the fixing belt 13 in a bend state at a predetermined curvature. The peeling roll 12 is a tubular member having an internal space (vent duct) 12a and is formed of a metal material such as aluminum or stainless steel, for example. The peeling roll 12 is supported on a support frame (not shown) for rotation and is urged elastically in the direction of giving a tension to the fixing belt 13 by a known tension giving mechanism made up of a spring, etc.

The fixing belt 13 is an endless belt made up of a belt base about 30 to 200 μm in thickness and an elastic mold release layer formed on the outer peripheral surface of the belt base and having a thickness of about 10 to 200 μm. The belt base is formed using a heat resistant resin of polyimide, polyamide, etc., or a metal material of nickel, aluminum, etc. The elastic mold release layer is formed of silicone base rubber, fluoro base rubber, etc.

The outer peripheral surface of the fixing belt 13 (specifically, the surface of the elastic mold release layer) may be a smooth surface (close to a mirror surface) as much as possible. The fixing belt 13 is stretched between the heating roll 11 and the peeling roll 12 and is run by rotation drive of the heating roll 11.

In further description, a paper guide 23 is placed so that the fixing belt 13 is opposed to it between the heating roll 11 and the peeling roll 12. Paper P transported in a state in which it is in intimate contact with the fixing belt 13 proceeds between the fixing belt 13 and the paper guide 23.

A temperature sensor 25 is placed close to the portion of the fixing belt 13 placed on the heating roll 11. This temperature sensor 25 is provided for detecting the surface temperature of the fixing belt 13.

The cooling device 14 forcibly cools the belt inner peripheral surface portion on the side of the fixing belt 13 from the heating roll 11 to the peeling roll 12 and is formed so that a plurality of fins 14a positioned on the radiation side extend in the width direction of the fixing belt 13.

The pressurization belt 15 is an endless belt and is supported for rotation by the pressure pad 16 placed in the pressurization belt 15, a guide member 19, and further a belt regulation member (not shown) placed in both and parts of the pressurization belt 15. The pressurization belt 15 is placed so as to be pressed against the heating roll 11 in a nip part N and is driven by the fixing belt 13 for rotation. Saying in addition, the nip part N for allowing paper P to pass through is formed between the fixing belt 13 and the pressurization belt 15 as the pressurization belt 15 is placed on the heating roll 11 through the fixing belt 13.

The pressurization belt 15 is supported by the pressure pad 16 and the guide member 19 in the area except both end parts of the pressurization belt 15 in the width direction thereof. In the area except both end parts of the pressurization belt 15, the inner peripheral surface of the pressurization belt 15 rotates while making sliding contact with a sliding retention sheet (low friction sheet) 20 placed so as to cover the pressure pad 16 and the guide member 19 and the guide member 13.

The pressure pad 15 is supported by the guide member 19 inside the pressurization belt 15. It is placed in a state in which it is pressed against the heating roll 11 through the pressurization belt 15, and forms the nip part N with the fixing belt 13. The pressure pad 16 has a soft pad (press part, pressure member) 21 placed for providing the wide nip part N on the entrance side of the nip part N (upstream). The pressure pad 16 locally presses the surface of the heating roll 11 on the exit side of the nip part N (downstream), thereby smoothing the surface of a toner image to give image glossiness.

The pressure pad 16 is provided with the sliding retention sheet 20 as an example of a sliding contact member on the face in Contact with the pressurization belt 15 to lessen the sliding resistance between the inner peripheral surface of the pressurization belt 15 and the pressure pad 16. The sliding retention sheet 20 is disposed in a state in which it is sandwiched between the pressure pad 16 and the inner peripheral surface of the pressurization belt 15 in all area of the nip part N.

A lubricant impregnated member (oil impregnated felt) 22 is disposed in the guide member 19 over the length direction of the fuser 10. The lubricant impregnated member 22 is placed so as to come in contact with the inner peripheral surface of the pressurization belt 15 and supplies a proper amount of a lubricant. Accordingly, a lubricant is supplied to the sliding part of the pressurization belt 15 and the sliding retention sheet 20 for further decreasing the sliding resistance between the pressurization belt 15 and the pressure pad 16 through the sliding retention sheet 20 to smoothly rotate the pressurization belt 15. The lubricant impregnated member 22 also has the effect of suppressing abrasion of the inner peripheral surface of the pressurization belt 15 and the surface of the sliding retention sheet 20

A heat insulation member (limitation part, limitation member, limitation section) 24 extending along the outer peripheral surface of the heating roll 11 is placed between the heating roll 11 and the cooling device 14. This heat insulation member 24 is disposed so as to partition the heating roll 11 and the cooling device 14. Thus, the heat insulation member 24 conducts heat insulation between the heating roll 11 and the cooling device 14 so that the heat of the heating roll 11 is not transferred to the cooling device 11. The heat insulation member 24 also prevents wind passing through the fins 14a from sweeping the heating roll 11. The heat insulation member 24 is attached to a frame (not shown).

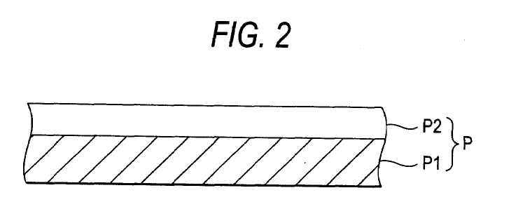

FIG. 2 is a schematic sectional view to describe paper P. As shown in FIG. 2, the paper P having transparent resin P2 having a thermoplastic resin as the component deposited on base P1 is used. Ordinary paper for image formation, coated paper photographic paper, etc., can be named as the base P1. Polyethylene resin, styrene-acrylic ester resin, etc., can be named as the thermoplastic resin forming the layer of the transparent resin P2. The layer of the transparent resin 22 may have a layer thickness to such an extent that it is fused by heating and pressurization at the fixing time and a toner image is embedded. The paper P is not limited if it is a record medium that can be applied to the image formation apparatus; The paper P shown in FIG. 2 may be used from the viewpoint of providing a photo-tinted image rich in glossiness by the fuser 10.

FIG. 3 is a schematic configuration drawing to describe air blowing in the fuser 10

As shown in FIG. 3, the fuser 10 includes the air blowing section (heat exhaust section, fan) 40. Air of the fins 14a (see FIG. 1) of the cooling device 14 and air of the internal space 12a (see FIG. 1) of the peeling roll 12 shaped like a cylinder are ejected to the outside of the fuser 10 by the air blowing section 40. As the air is ejected, the heat of the cooling device 14 and the heat of the peeling roll 12 are exhausted to the outside of the fuser 10. Thus, one air blowing section 40 takes heat from the fins 14a of the cooling device 14 for cooling and also cools the peeling roll 12.

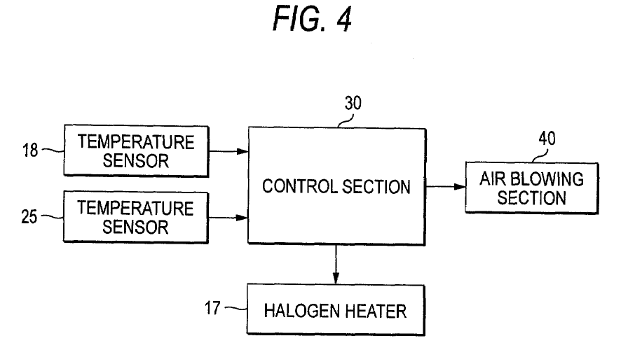

FIG. 4 is a block diagram to describe control of a control section 30.

As shown in FIG. 4, the temperature sensor 18 is placed on the surface of the peeling roll 12 (see FIG. 1) and outputs the detected temperature to the control section 30. The temperature sensor 25 is placed in the proximity of the fixing belt 13 and outputs the detected temperature to the control section 30. The control section 30 control the halogen heater 17 and the air blowing section 40 in response to the detection results of the temperature sensors 18 and 25. That is, the control section 30 controls the air blowing section 40 so that the temperature of the peeling roll 12 (see FIG. 1) maintains setup temperature (for example, 40° C.) based on the temperature measurement value of the temperature sensor 18. The cooling device 14 as well as the peeling roll 12 (see FIG. 1) is maintained at the setup temperature as the air blowing section 40 is thus controlled.

The control section 30 also controls turning on the halogen heater 17 so that the surface temperature of the fixing belt 13 (see FIG. 1) maintains setup temperature (for example, 175° C.) based on the temperature measurement value of the temperature sensor 25.

Next, the operation of the fuser 10 is as follows: When the fixing operation timing comes, the heating roll 11 shown in FIG. 1 starts to rotate so as to run the fixing belt 13 and the halogen heater 17 generates heat by energization for heating the heating roil 11 to a predetermined fixing temperature and holds the heating roll 11 at the temperature under the control of the control section 30. At this time, the pressurization belt 15 is driven in response to rotation of the heating roll 11 through the fixing belt 13 and starts to rotate. The air blowing section 40 for exhausting the heat of the peeling roll 12 and the heat of the cooling device 14 starts to operate before the fixing operation is started under the control of the control section 30. Thus, the nip part N is heated to the predetermined fixing temperature and the fixing belt 13 is forcibly cooled by the cooling device 14.

Then, the paper P to which a toner image formed in response to image information by the image formation apparatus is transferred is fed into the nip part N through a fixing entrance guide (not shown) of the fuser 10. Then, when the paper P passes through the nip part N, the toner image on the paper P is fused by pressure acting on the nip part N and heat supplied from the fixing belt 13 and is also embedded in the paper P (fuse and press step). The paper P with the toner image thus fixed is transported with rotation of the fixing belt 13 in a state in which it abuts (is in intimate contact with) the outer peripheral surface of the fixing belt 13 still after the paper F passes through the nip part N.

When the paper P is transported in the state in which it abuts the fixing belt 13, the paper P is cooled by the cooling device 14 (cooling step). That is, the heat of the paper P passing through the nip part N is transmitted to the fixing belt 13 cooled by the cooling device 14 and is dissipated. At the time, the fins 14a of the cooling device 14 blow air by the air blowing section 40 (see FIG. 3) and the heat insulation member 24 prevents the heat of the heating roll 11 from being transmitted to the cooling device 14, so that heat is dissipated efficiently in the cooling device 14. Thus, the toner image and the paper P are cooled and are almost fixed in a state in which the toner image is embedded in the paper P.

The cooled paper P is transported to the peeling roll 12 in the state in which it abuts the fixing belt 13 and is naturally peeled off from the fixing belt 13 placed on the peeling roll 12 as the rotation state with curvature of the fixing belt 13 placed on the peeling roll 12 and firmness of the paper P are mutually contradictory (peeling step). Accordingly, the fixing is complete. Then, the paper P peeled off from the fixing belt 13 is sent to a storage tray (not shown) by an ejection roll (not shown).

When fixing of the fuser 10 is performed normally, as a result of uniform cooling particularly in the cooling area, the fixing is performed in a state in which the toner image is uniformly embedded in the paper P and the surface of the paper P after the fixing becomes excellent in smoothness following the smooth surface of the fixing belt 13. That is, the image on the paper P after the fixing is obtained as an image of high image quality with less irregular reflection of light caused by surface asperities, rich in glossiness, and close to a photo image.

The internal space 12a of the peeling roll 12 is cooled as the air blowing section 40 (see FIG. 3) blows air. Thus, the paper P cooled by the cooling device 14 is peeled off from the fixing belt 13 without being again heated by the peeling roll 12.

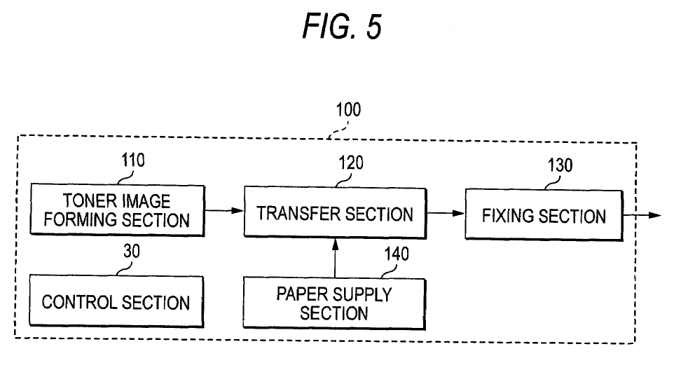

FIG. 5 is a block diagram to describe the configuration of an image formation apparatus 100 incorporating the fuser 10.

The fuser 10 according to the first exemplary embodiment described above can be applied to the image formation apparatus 100 using electrophotography, such as a copier, a facsimile, or a multiple function processing machine. The image formation apparatus 100 shown in FIG. 5 includes toner image formation section 110 for forming a toner image, transfer section 120 for transferring the toner image formed by the toner image formation section 110 onto the paper P, fixing section 130 for fixing the toner image transferred onto the paper P on the paper P, and paper supply section 140 for supplying the paper P to the transfer section 120 at a predetermined timing. The fuser 10 according to the first exemplary embodiment described above can be used as the fixing section 130. As other components than the fuser 10, any known components can be used so long as they do not violate the object of the invention. The toner image formation section 110 is made up of an electrostatic latent image formation section for forming an electrostatic latent image on an electrostatic latent image support and a developing section for developing the electrostatic latent image in toner.

### Second Exemplary Embodiment

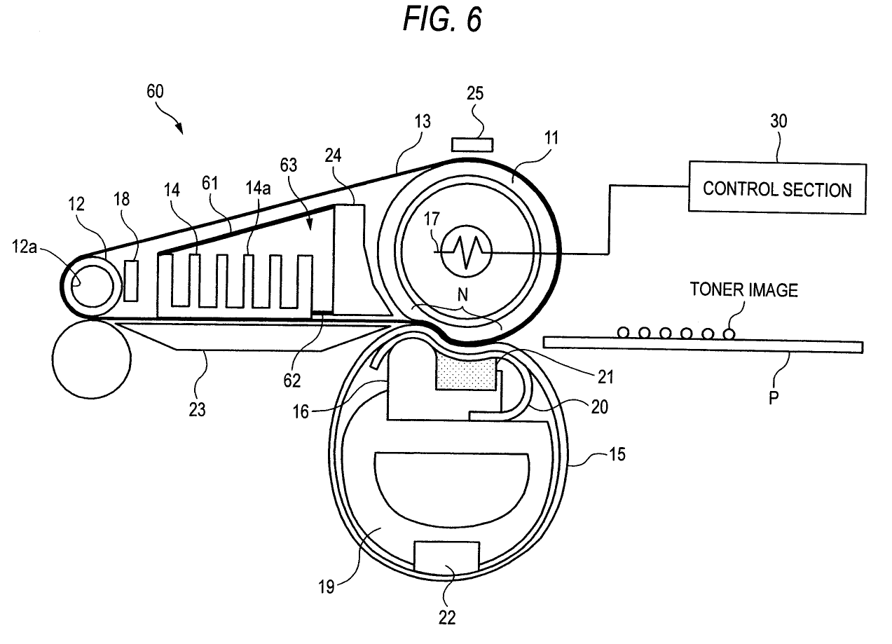

FIG. 6 is a sectional side view to show the configuration of a fuser 60 according to a second exemplary embodiment of the invention.

The fuser 60 shown in FIG. 6 has the same basic configuration as the fuser 10 according to the first exemplary embodiment. Components identical with those of the fuser 10 are denoted by the same reference numerals and will not be discussed again. Components different from those of the fuser 10 will be discussed.

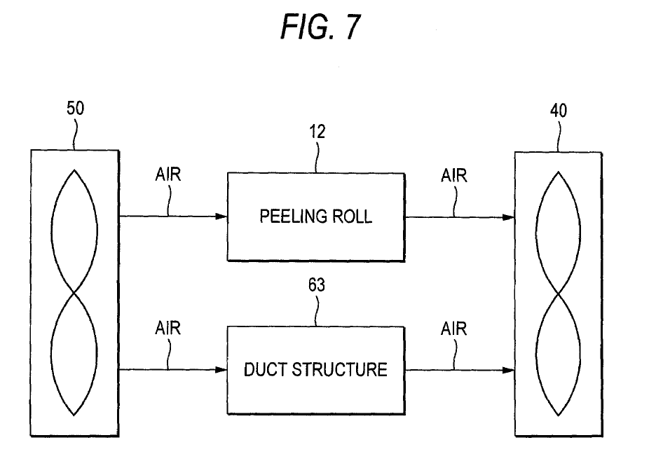

The fuser 50 includes cover members 61 and 62 extending in the width direction of a fixing belt 13 (vertical direction to the plane of the figure) and attached to a cooling device 14 and a heat insulation member 24. That is, the cover member 61 is attached to the upper end part of the cooling device 14 to peeling roll 12 and the upper end part of the heat insulation member 24. The cover member 62 is attached to the lower end part of the cooling device 14 to a heating roll 11 and the lower end part of the heat insulation member 24. The cooling device 14, the heat insulation member 24, and the cover members 61 and 62 make up a duct structure 63 open at both ends for allowing air blown from an air blowing section 40 (see FIG. 7) to pass through.

FIG. 7 is a schematic configuration drawing to describe air blowing in the fuser 60.

As shown in FIG. 7, the fuser 60 includes air blowing sections 40 and 50. The air blowing sections 40 and 50 are placed at a distance from each other and the peeling roll 12 is placed therebetween. The duct structure 63 made up of the cooling device 14, the heat insulation member 24, and the cover members 61 and 62 is also placed between the air blowing sections 40 and 50.

Air blown from the air blowing section 50 passes through the duct structure 63 and an internal space 12a (see FIG. 6) of the peeling roll 12. The blown air passing through the duct structure 63 takes heat from fins 14a of the cooling device 14 for cooling, and also cools the peeling roll 12. Further, in the second exemplary embodiment, the blown air passing through the duct structure 63 and the peeling roll 12 is forcibly ejected to the outside of the fuser 60 by the air blowing section 40.

### Third Exemplary Embodiment

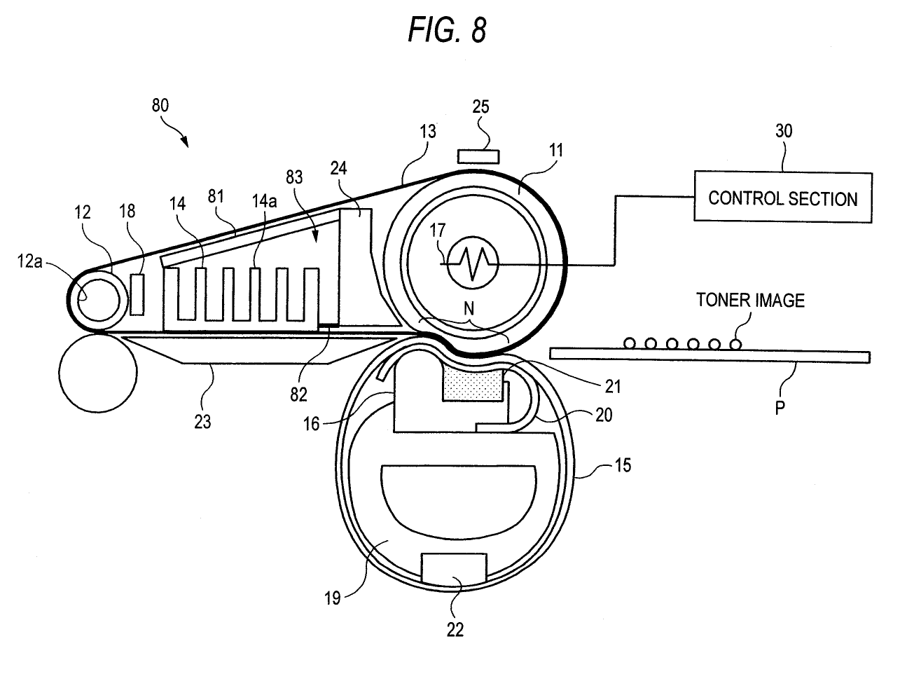

FIG. 8 is a sectional side view to show the configuration of a fuser 80 according to a third exemplary embodiment of the invention.

The fuser 80 shown in FIG. 8 also has the same basic configuration as the fuser 10 according to the first exemplary embodiment. Components identical with those of the fuser 10 are denoted by the same reference numerals and will not be discussed again, components different from those of the fuser 10 will be discussed.

The fuser 80 includes a heat insulation member (another limitation members another limitation section) 81 and a cover member 82 extending in the width direction of a fixing belt 13 (vertical direction to the plane of the figure) and attached to a cooling device 14 and a heat insulation member 24. That is, the heat insulation member 81 is attached to the upper and part of the cooling device 14 to a peeling roll 12 and the upper end part of the heat insulation member 24. The cover member 82 is attached to the lower end part of the cooling device 14 to a heating roll 11 and the lower end part of the heat insulation member 24. The cooling device 14, the heat insulation members 24 and 81, and the cover member 82 make up a duct structure 83 open at both ends for allowing air blown from an air blowing section 40 (see FIG. 3) to pass through.

The heat insulation member 81 insulates heat between the portion of the fixing belt 13 passing through the peeling roll 12 and the cooling device 14. That is, the heat insulation member 81 prevents the heat of the portion of the fixing belt 13 passing through the cooling device 14 and the peeling roll 12 and cooled from having an effect on the cooling device 14. Specifically, the heat insulation member 81 limits a move of heat from the fixing belt 13 to the cooling device 14 so as not to hinder heat radiation in fins 14a of the cooling device 14. It is also possible to use a heat insulation member in place of the cover member 82.

### Fourth Embodiment

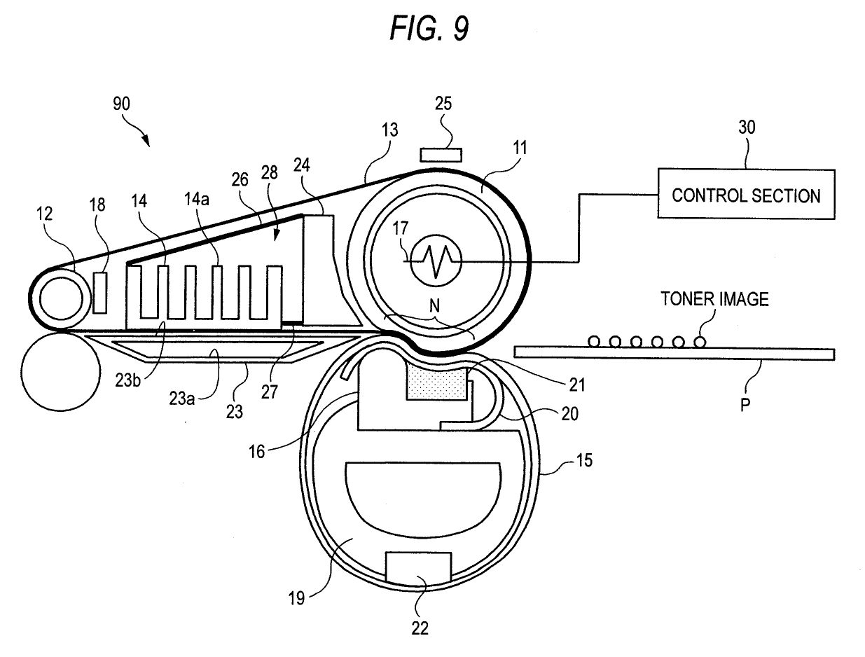

FIG. 9 is a sectional side view to show the configuration of a fuser 90 according to a fourth exemplary embodiment of the invention.

The fuser 90 shown in FIG. 9 has the same basic configuration as the fuser 10 according to the first exemplary embodiment. Components identical with those of the fuser 10 are denoted by the same reference numerals and will not be discussed again. Components different from those of the fuser 10 will be discussed.

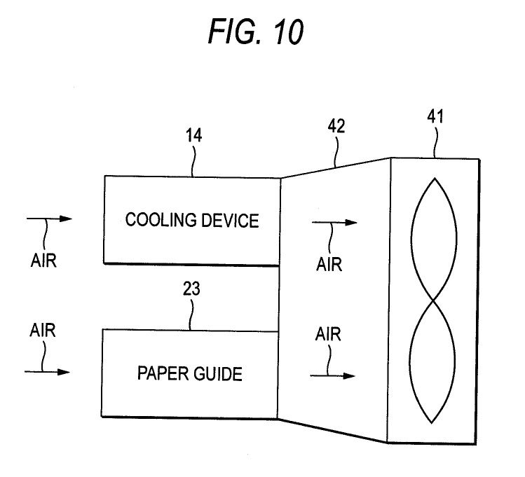

A paper guide 23 (another cooling section) is placed so that the fixing belt 13 is opposed to it between the heating roll 11 and the peeling roll 12. That is, the paper guide 23 is positioned on the outer peripheral surface side of the fixing belt 13. Paper P transported in a state in which it is in intimate contact with the fixing belt 13 proceeds between the fixing belt 13 and the paper guide 23 while it is guided by the paper guide 23. The paper guide 23 has an internal space 23a through which air blown from an air blowing section 41 (see FIG. 10) passes. The paper guide 23 also has a guide face 23b for coming in contact with the paper P for guiding the paper P.

A temperature sensor 25 is placed close to the portion of the fixing belt 13 placed on the heating roll 11. This temperature sensor 25 is provided for detecting the surface temperature of the fixing belt 13.

In the fourth exemplary embodiment, although the heat insulation member 24 is placed between the heating roll 11 and the cooling device 14, it is also possible to further place the heat insulation member 24 between the pressurization belt 15 and the paper guide 23. It is also possible to place the heat insulation member 24 only between the pressurization belt 15 and the paper guide 23 depending on the layout of the component.

The fuser 10 includes cover members 26 and 27 extending in the width direction of the fixing belt 13 (vertical direction to the plane of the figure) and attached to the cooling device 14 and the heat insulation member 24. That is, the cover member 26 is attached to the upper end part of the cooling device 14 to the peeling roll 12 and the upper end part of the heat insulation member 24. The cover member 27 is attached to the lower end part of the cooling device 14 to the heating roll 11 and the lower and part of the heat insulation member 24. The cooling device 14, the heat insulation member 24, and the cover members 26 and 27 make up a duct section 28 open at both ends for allowing air introduced into the air blowing section 41 (see FIG. 10) to pass through.

FIG. 10 is a schematic configuration drawing to describe air blowing in the fuser 90.

As shown in FIG. 10r the fuser 90 includes the air blowing section (heat exhaust section, fan) 41. It also includes a connection section 42 for connecting the duct section 28 (see FIG. 9) of the cooling device 14 and the air blowing section 41 and also connecting the internal space 23a (see FIG. 9) of the paper guide 23 and the air blowing section 41.

Air of the duct section 28 (see FIG. 9) and air of the internal space 23a (see FIG. 9) are the paper guide 23 are ejected to the outside of the fuser 90 by the air blowing section 41 through the connection section 42. As the air is ejected, the heat of the cooling device 14 forming a part of the duct section 28 is exhausted to the outside of the fuser 90 and the heat of the paper guide 23 is exhausted to the outside of the fuser 90. Thus, one air blowing section 41 takes heat from the fins 14a of the cooling device 14 for cooling and also cools the paper guide 23.

We describe control of a control section 30 shown in FIG. 4 according to a fourth exemplary embodiment of the invention

The temperature sensor 18 is placed on the surface of the peeling roll 12 (see FIG. 9) and outputs the detected temperature to the control section 30. The temperature sensor 25 is placed in the proximity of the fixing belt 13 and outputs the detected temperature to the control section 30. The control section 30 controls the halogen heater 17 and the air blowing section 41 in response to the detection results of the temperature sensors 18 and 25. That is, the control section 30 controls the air blowing section 41 so that the temperature of the peeling roll 12 (see FIG. 9) maintains setup temperature (for example, 40° C.) based on the temperature measurement value of the temperature sensor 18. The temperatures of the Cooling device 14 and the paper guide 23 are maintained at the setup temperatures and the temperature of the paper P transported by the fixing belt 13 (see FIG. 9) is maintained at the setup temperature as the air blowing section 41 is thus controlled.

The control section 30 also controls turning on the halogen heater 17 so that the surface temperature of the fixing belt 1s (see FIG. 10) maintains setup temperature (for example, 175° C.) based on the temperature measurement value of the temperature sensor 25.

Next, the operation of the fuser 90 is as follows: When the mixing operation timing comes, the heating roll 11 shown in FIG. 9 starts to rotate so as to run the fixing belt 13 and the halogen heater 17 generates heat by energization for heating the heating roll 11 to a predetermined fixing temperature and holds the heating roll 11 at the temperature under the control of the control section 30. At this time, the pressurization belt 15 is driven in response to rotation of the heating roll 11 through the fixing belt 13 and starts to rotate. The air blowing section 41 for cooling the cooling device 14 and the paper guide 23 starts to operate before the fixing operation is started under the control of the control section 30. Thus, the nip part N is heated to the predetermined fixing temperature and the fixing belt 13 is forcibly cooled by the cooling device 14 and the paper guide 23.

Then, the paper P to which a toner image formed in response to image information by the image formation apparatus is transferred is fed into the nip part N through a fixing entrance guide (not shown) of the fuser 90. Then, when the paper P passes through the nip part N, the toner image on the paper P is fused by pressure acting on the nip part N and heat supplied from the fixing belt 13 and is also embedded in the paper P (fuse and press step). The paper P with the toner image thus fixed is transported with rotation of the fixing belt 13 in a state in which it abuts (is in intimate contact with) the outer peripheral surface of the fixing belt 13 still after the paper P passes through the nip part N.

When the paper P is transported in the state in which it abuts the fixing belt 12, the paper P is cooled by the cooling device 14 and the paper guide 23 from both sides of the image side and the non-image side (cooling step). That is, the heat of the paper P passing through the nip part N is transmitted to the fixing belt 13 cooled by the cooling device 14 and is also transmitted to the paper guide 23. Since the cooling device 14 and the paper guide 23 are cooled by air blown by the air blowing section 41, the heat transmitted to the cooling device 14 and the paper guide 23 is dissipated. Saying in addition, the heat in the area between the fixing belt 13 and the paper guide 23 where the paper P passes through is transmitted to the paper guide 23 and is dissipated.

The heat insulation member 24 positioned between the heating roll 11 and the cooling device 14 prevents the heat of the heating roll 11 from being transmitted to the cooling device 14. Thus, the toner image and the paper P are cooled and are almost fixed in a state in which the toner image is embedded in the paper P.

The cooled paper P is transported to the peeling roll 12 in the state in which it abuts the fixing belt 13 and is naturally peeled off from the fixing belt 13 placed on the peeling roll 12 as the rotation state with curvature of the fixing belt 13 placed on the peeling roll 12 and firmness of the paper P are mutually contradictory (peeling step). Accordingly, the fixing is complete. Then, the paper P peeled off from the fixing belt 13 is sent to a storage tray (not shown) by an ejection roll (not shown).

When fixing of the fuser 90 is performed normally, as a result of uniform cooling particularly in the cooling area, the fixing is performed in a state in which the toner image is uniformly embedded in the paper P and the surface of the paper P after the fixing becomes excellent in smoothness following the smooth surface of the fixing belt 13. That is, the image on the paper P after the fixing is obtained as an image of high image quality with less irregular reflection of light caused by surface asperities, rich in glossiness, and close to a photo image.

Some modified examples of the exemplary embodiments are possible. The modified examples will be discussed below:

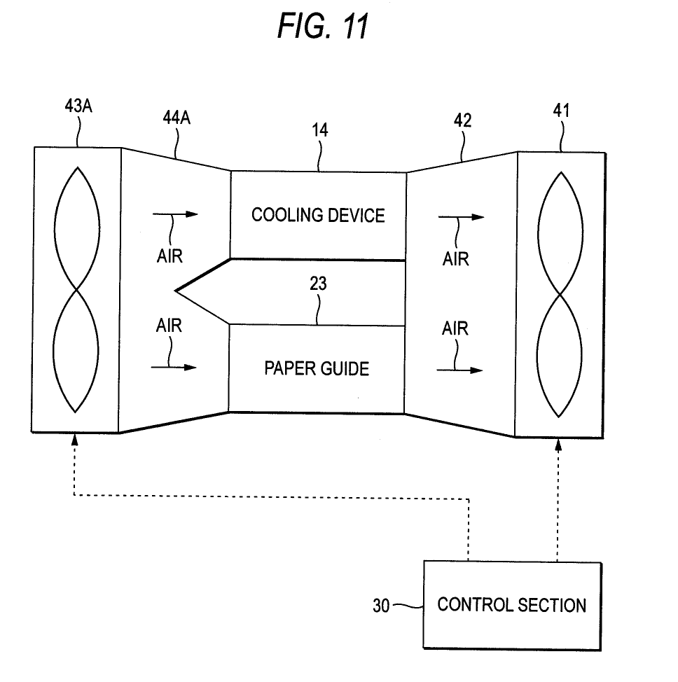

FIG. 11 is a schematic configuration drawing to describe air blowing in the fuser 90 according to a modified example.

In the configuration shown in FIG. 11, an air blowing section 43A for blowing air into the cooling device 14 and the paper guide 23 and a connection section 44A for connecting the air blowing section 43A and the cooling device 14 and the paper guide 23 are included in addition to the air blowing section 41 and the connection section 42 described above. That is, air is forcibly blown into the cooling device 14 and the paper guide 23 by the air blowing section 43A and is forcibly ejected to the outside of the fuser 90 by the air blowing section 41. The air blowing section 43A is controlled by the control section 30.

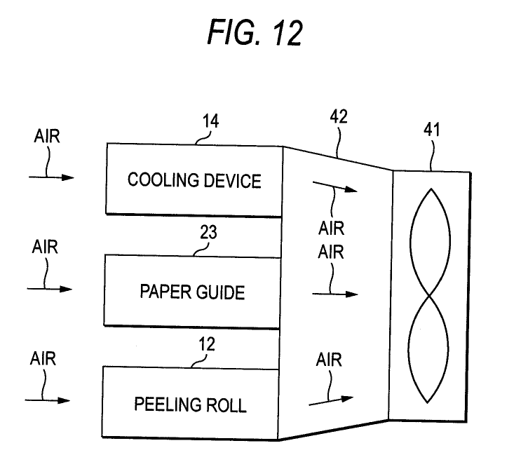

FIG. 12 is a schematic configuration drawing to describe air blowing in the fuser 90 according to another modified example.

In the configuration shown in FIG. 12, the peeling roll 12 as well as the cooling device 14 and the paper guide 23 is connected to the connection section 42 described above. The peeling roll 12 is shaped like a cylinder and allows air to pass through the inside thereof. Thus, the air inside the peeling roll 12 is ejected to the outside of the fuser 90 by the air blowing section 41 through the connection section 42 and accordingly the heat that the peeling roll 12 receives from the fixing belt 13 and the paper P is ejected to the outside of the fuser 90. In the modified example, the heat of the peeling roll 12 is ejected by the air blowing section 41, so that the paper P cooled by the cooling device 14 and the paper guide 23 is peeled off from the fixing belt 13 without being again heated by the peeling roll 12.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fuser comprising:
a fusing press section that has a fixing belt given heat and a pressurization member pressed against the fixing belt to form a nip part therebetween, the fusing press section that fuses a toner image on a record sheet by the heat of the fixing belt and fixes the toner image on the record sheet under pressure when the record sheet passes through the nip part;
a cooling section that cools the record sheet which has the toner image fused and fixed thereon under pressure by the fusing press section and which is attached onto the fixing belt;
a peeling section that peels off the record sheet cooled by the cooling section from the fixing belt; and
a limitation section that is disposed between the fusing press section and the cooling section, the limitation section that limits a move of heat from the fusing press section to the cooling section.

2. The fuser as claimed in claim 1,
wherein the limitation section limits the move of the heat from the fixing belt to the cooling section in any other area than an area in which the record sheet attached onto the fixing belt is cooled by the cooling section.

3. The fuser as claimed in claim 1 further comprising:
a heat exhaust section that exhausts heat of the cooling section to an outside of the fuser, wherein
the heat exhaust section also exhausts heat of the peeling section to the outside of the fuser.

4. The fuser as claimed in claim 1, further comprising:
a heat exhaust section that exhausts heat of cooling section to an outside of the fuser by air, wherein
the limitation section comprises a partition between the fusing press section and the cooling section so as to restrict air, which is exhausted together with heat by the heat exhaust section, from moving to the fusing press section.

5. The fuser as claimed in claim 4, further comprising:
a cover member that is attached to the cooling section and the limitation section, wherein
the cover member, the cooling section and the limitation section form a duct structure through which the air passes.

6. A fuser comprising:
a heat source;
a fixing belt that receives supply of heat from the heat source;
a pressurization member that is disposed so as to come in contact with the fixing belt;
a press member that forms a nip part between the fixing belt and the pressurization member, a record sheet that passes through the nip part;
a peeling member around which the fixing belt is wound, the peeling member that peels off the record sheet attached onto the fixing belt in the nip part;
a cooling device that cools the record sheet attached to the fixing belt; and
a limitation member that is placed between the cooling device and the heat source, the limitation section that limits a move of heat from the heat source to the cooling device.

7. The fuser as claimed in claim 6, further comprising:
a heat exhaust section that exhausts heat of the cooling device to an outside of the fuser; and
a cover member that is attached to the cooling device and the limitation member, wherein
the cover member, the cooling device and the limitation member form a duct structure, and
air exhausted together with the heat by the heat exhaust section passes thorough the duct structure.

8. The fuser as claimed in claim 6, further comprising:
another limitation member that limits a move of heat from the fixing belt to the cooling device in any other area than an area in which the record sheet attached to the fixing belt is cooled by the cooling device.

9. The fuser as claimed in claim 6, further comprising:
a heat exhaust section that exhausts heat of the cooling device to an outside of the fuser, wherein
the heat exhaust section also exhausts heat of the peeling member to the outside of the fuser.

10. An image formation apparatus comprising:
a toner image formation section that forms a toner image;
a transfer section that transfers the toner image formed by the toner image formation section onto a record sheet;
a fixing section that fires the toner image, which is transferred onto the record sheet, on the record sheet; and
the fuser as claimed in claim 1.

11. A fuser comprising:
a fusing press section that includes a fixing belt given heat and a pressurization member pressed against the fixing belt to form a nip part therebetween, the fusing section fuses a toner image on a record sheet by heat of the fixing belt and fixes the toner image on the record sheet under pressure when the record sheet passes through the nip part;
a first cooling section that is disposed on an inner peripheral surface side of the fixing belt, the first cooling section that cools the record sheet which has the toner image fused and fixed thereon under pressure by the fusing press section and which is attached onto the record sheet on the fixing belt;
a second cooling section that is disposed on an outer peripheral surface side of the fixing belt, the second cooling section that cools an opposite surface of the record sheet to another surface of the record sheet attached onto the fixing belt; and
a peeling section than peels off the record sheet, which is cooled by the first cooling section and the second cooling section, from the fixing belt.

12. The fuser as claimed in claim 1S, further comprising:
a limitation section that is placed between (i) the fusing press section and (ii) at least one of the first cooling section and the second cooling section, wherein
the limitation section limits a move of heat from the fusing press section to the at least one of the first cooling section and the second cooling section.

13. The fuser as claimed in claim 11,
wherein the second cooling section includes a guide face of the record sheet.

14. The fuser as claimed in claim 11, further comprising:
a heat exhaust section that exhausts heat of the first cooling section and heat of the second cooling section to an outside of the fuser, and
a connection section that thermally connects the first cooling section and the second cooling section to the heat exhaust section.

15. A fuser comprising:
a heat source;
a fixing belt that receives supply of heat from the heat source;
a pressurization member that is disposed so as to come in contact with the fixing belt;
a press member that forms a nip part between the fixing belt and the pressurization member, a record sheet that passes through the nip part;
a peeling member around which the fixing belt is wound, the peeling member that peels off the record sheet attached onto the fixing belt in the nip part;
a first cooling device that cools an image side of the record sheet attached to the fixing belt; and
a second cooling device that cools a non-image side of the record sheet attached to the fixing belt.

16. The fuser as claimed in claim 15, further comprising:
a limitation section that is disposed between (i) the heat source and (ii) at least of the first cooling device and the second cooling device, wherein
the limitation section limits a move of heat from the heat source to the at least of the first cooling device and the second cooling device.

17. The fuser as claimed in claim 15, further comprising:
a heat exhaust section that exhausts heat of the first cooling device and heat of the second cooling device to an outside of the fuser; and
a connection section that thermally connects the first cooling device and the second cooling device to the heat exhaust section.

18. The fuser as claimed in claim 17, further comprising:
the heat exhaust section that exhausts the heat of the first cooling device, the heat of the second cooling device and heat of the peeling member to the outside of the fuser; and
the connection section that connects the first cooling device, the second cooling device, and the peeling member to the heat exhaust section.
